(19) United States
(12) Patent Application Publication
(10) Pub. No.: US 2026/0120308 A1
(43) Pub. Date: Apr. 30, 2026

(54) AUTOMATIC MEASUREMENT OF RACING VEHICLE DETAILS

(71) Applicants: Constructor Technology AG, Schaffhausen (CH); Constructor Education and Research Genossenschaft, Schaffhausen (CH)

(72) Inventors: Andrei Boiarov, Sofia (BG); Dmitry Bleklov, Sofia (BG); Pavlo Bredikhin, Khariv (UA); Nikita Koritskii, Berlin (DE); Sergey Ulasen, Singapore (SG); Serg Bell, Costa del Sol (SG); Stanislav Protasov, Singapore (SG); Laurent Dedenis, Geneva (CH); Nikolay Dobrovolskiy, Istambul (TR)

(21) Appl. No.: 18/933,475

(22) Filed: Oct. 31, 2024

(51) Int. Cl. G06T 7/62; G06V 10/26

(52) U.S. Cl. CPC G06T 7/62; G06V 10/26; G06V 2201/08; G06V 2201/12

(57) ABSTRACT

Systems and methods for analyzing images using deep learning and computer vision models. Automatic analysis of photographic images allows, for example, for the identification of important elements in these images, such as detection and measurement of vehicle details of interest to racing teams. Racing vehicles, typically cars that use standardized components, have specific geometry that can be detected and used for specific detection tasks.

### TECHNICAL FIELD

The present disclosure generally relates to applications of computer vision models to analysis of images, specifically the analysis of photographic images.

### BACKGROUND

Racing teams have traditionally relied on manual and time-consuming methods to analyze racing photos. Teams have traditionally manually identified cars, their numbers, and brands by examining individual photos. This process is tedious, prone to errors, and often delays the extraction of valuable insights. Due to the manual nature of the process, teams have been limited in the amount of data they can analyze. This hinders the ability to make informed decisions and gain a comprehensive understanding of race dynamics. The manual analysis of racing photos often leads to subjective evaluations and interpretations. This can result in inconsistencies and biases in the analysis, affecting the accuracy and reliability of the insights derived. Moreover, traditional manual examination has required teams to allocate significant resources and time to the analysis of racing photos. This has diverted resources away from other critical areas, such as strategy development and driver performance optimization.

Thus, there is a need for improved systems and methods for quickly processing vast amounts of data that can give objective and consistent insights to support racing vehicle decision-making.

### SUMMARY

A computer-implemented method for automatically measuring and displaying attributes of racing vehicle images is disclosed. A test image comprising a racing vehicle is passed to a first machine-learning model configured to identify an attribute of the racing vehicle. The first attribute comprises a component of a racing vehicle with a known distance d. The first machine-learning model identifies the attribute and the test image is cropped to emphasize the first attribute. The test image is passed to a second machine-learning model configured to predict the coordinates of at least four properties of the first attribute of the racing vehicle. In one embodiment, the second machine-learning model identifies the coordinates of the at least four properties of the first attribute of the racing vehicle. A first measurement of the first attribute is calculated using the coordinates of the at least four properties of the attribute and known distance d. A second measurement of a second attribute is calculated using the first measurement as an input. The calculated value of the second measurement is displayed on a graphical user interface. In an embodiment, a component of a racing vehicle corresponding to the second attribute based on the calculated value of the second measurement can be changed.

In an embodiment, the first attribute is a first wheel of the racing vehicle and the first distance is the radius of the first wheel. The second machine-learning model can identify the coordinates of the at least four properties of the first attribute of the racing vehicle and define a matrix transformation based on the coordinates of the at least four properties of the first attribute of the racing vehicle and a reference point. The second machine-learning model can then correct the digital test image using the transformation matrix.

The second measurement can be the distance between the first wheel of the racing vehicle and a second wheel of the racing vehicle. In an embodiment, the known distance d is a wheel disk radius. The at least four properties of the first attribute can be locations on the first wheel, such as coordinates of the top, bottom, left side, and right side of the first wheel. In some embodiments, the at least four properties further comprise the center of the first wheel and the point at which a tire coupled to the first wheel touches the ground.

A system for identifying attributes of racing vehicles from test images is also disclosed. The system comprises a test image of a racing vehicle, a microprocessor processor coupled to a nonvolatile storage medium, configured with instructions that, when executed by the processor, control a plurality of machine-learning modules. The modules comprise, for example, a first machine-learning model trained to identify an attribute of a racing vehicle. The first attribute comprises a component of a racing vehicle with a known distance d. A second machine-learning model trained to predict at least four properties of the attribute of the racing vehicle is configured to predict the coordinates of the at least four properties. A software module, under microprocessor control, is configured for calculating a first measurement of the first attribute using the coordinates of the at least four properties of the attribute and known distance d. The software module is further configured for calculating a second measurement of a second attribute using the first measurement as an input. A graphical user interface is provided, under microprocessor control, and configured for displaying the second measurement to a user. In an embodiment, the software module is further configured for changing a component of a racing vehicle corresponding to the second attribute based on the calculated value of the second measurement.

Various embodiments of the system are similar to the method embodiments. For example, in an embodiment the first attribute is a first wheel of the racing vehicle and the first distance is the radius of the first wheel. The second measurement is the distance between the first wheel of the racing vehicle and a second wheel of the racing vehicle—and the known distance d can be a wheel disk radius. The at least four properties of the first attribute can be coordinates on the first wheel and the at least four properties can comprise coordinates of the top, bottom, left side, and right side of the first wheel.

Also disclosed is a computer-implemented method for training a plurality of machine-learning models for measuring attributes of racing vehicles. Training images of a plurality of racing vehicles are collected and a first machine-learning model is trained with the plurality of training images to identify a first attribute of the racing vehicles. A second machine-learning model is trained to predict the coordinates of at the least four properties of the first attribute of the racing vehicles. A test image of a racing vehicle is then passed to the first machine-learning model. The first machine-learning model detects a bounding box of the first attribute. The test image is cropped to emphasize the bounding box of the first attribute and the cropped test image is passed to the second machine-learning model. The second machine-learning model identifies the coordinates of the at least four properties and a first measurement of the first attribute is calculated using the coordinates of the at least four properties of the attribute and the known distance d. A second measurement of a second attribute is calculated using the first measurement as an input and the calculated value of the second measurement is displayed on a graphical user interface. In an embodiment, a component of a racing vehicle corresponding to the second attribute based on the calculated value of the second measurement is changed.

Alternative embodiments are the same as for the method and system described above.

### BRIEF DESCRIPTION OF THE DRAWINGS

FIG. 1 is an exemplary block diagram of a racing wheel, according to an embodiment.

FIG. 2 is an exemplary graphical user interface (GUI) of an application for analysis of racing images, according to an embodiment.

FIG. 3 is a table showing an exemplary dataset of images from NASCAR racing environments, according to an embodiment.

FIG. 4 is a table showing exemplary detection-accuracy results for various models in terms of standard mean average precision (mAP), according to an embodiment.

FIG. 5 is a table of exemplary orientation-detection results obtained in an embodiment, according to an embodiment.

FIG. 6 is a block diagram of a system for analysis of racing images, according to an embodiment.

FIG. 7 is a flowchart of a method for automatic measurement of racing car details, according to an embodiment.

The embodiments described are exemplary ways to use the invention to solve technical problems in the field of the invention. The solutions and techniques disclosed may also be used to solve other problems in the field or to solve similar problems in other fields. Substitutions, modifications, and equivalents known to those of skill in the art may be used to implement these solutions and techniques, consistent with scope of the invention described in the claims.

### DETAILED DESCRIPTION

Images are analyzed in a racing environment using deep learning and computer vision models. Automatic analysis of digital photographic images by a sequence of models allows for the identification of specific car details, such as wheel sizes. Racing vehicles, typically cars, have specific attributes that can be detected by customized modules adapted to specific detection tasks. Computer-implemented methods are used to identify these attributes, which include various details of racing vehicles. The sequence of models used increases the speed and accuracy of attribute identification. This identification includes real-world measurements for racing vehicle details, which are extracted from images without any particular scale. The automatically generated measurements of vehicle details can be used, particularly by racing teams, to analyze competing vehicles and to make changes in vehicle design. Such changes include, for example, replacing or modifying vehicle components.

In an embodiment, at least one processor and a memory operably coupled to the at least one processor can include instructions that, when executed by the at least one processor, cause the at least one processor to implement modules described herein. Embodiments comprise a module for measurement of car details. A direct correlation between image distances is established. Image distance is measured in pixels and real-world distances are measured in millimeters or inches. The direct correlation is achieved by detecting specific persistent parts of the car. In an embodiment, a standardized part size is used for reference. For example, a standardized wheel disk size is used for NASCAR racing cars. The standardized part size allows for consistent measurements across multiple images that include the standardized part. For example, the standard wheel disk size can be used to help identify wheel disks in images with other car parts.

Multiple models are used for image analysis. For example, a dedicated model is configured for detecting wheel bounding boxes and another dedicated model is configured for car orientation.

In an embodiment, the car-orientation model described below is used for detection of car orientation. The models operate on all frames and do not require pixel-wise accuracy. A wheel keypoints model is specifically configured to operate on images of cars from a side position such as the pitstop line. The car positioning allows for the wheels to be seen in profile, which minimizes the distortion due to perspective. Wheel crops obtained from the previous step are passed to the Keypoint R-CNN with ResNet-50 backbone. Alternatively, other key-point detection models may be used. Some examples include Faster R-CNN, Mask R-CNN, YOLO (You Only Look Once), SSD (Single Shot MultiBox Detector), RetinaNet, and EfficientDet.

Keypoint R-CNN is an advanced model that builds upon the Mask R-CNN framework, itself an extension of Faster R-CNN for object detection and instance segmentation. In Keypoint R-CNN, the core architecture comprises a deep convolutional Backbone Network for feature extraction and a Region Proposal Network (RPN) for generating candidate object bounding boxes. The unique aspect of Keypoint R-CNN lies in its ROI Head, which, in addition to the class labels, bounding box offsets, and object masks produced by Mask R-CNN, includes a keypoint detection head. This keypoint head is responsible for predicting keypoints within each Region of Interest (ROI), outputting a heatmap for each keypoint type. In practice, using tools like PyTorch and torchvision, a pre-trained Keypoint R-CNN model can be used to process images, where the model outputs bounding boxes, keypoints, and keypoint scores for each detected object. In an embodiment, a deep convolutional neural network, such as ResNet-50 with 50 layers, is used as the backbone architecture in Keypoint R-CNN for feature extraction. In this embodiment, ResNet-50 processes the input image to generate a rich feature map. This feature map is then used by the subsequent layers of Keypoint R-CNN, particularly the Region Proposal Network (RPN) and the ROI Head. The RPN uses these features to propose candidate regions (bounding boxes) that potentially contain objects. Then for each proposed region the ROI Head's Box Head refines the bounding box and classifies the object, while the Keypoint Head predicts the location of various keypoints within the box. ResNet-50 provides a deep understanding of the visual content, enabling Keypoint R-CNN to effectively detect objects and their keypoints.

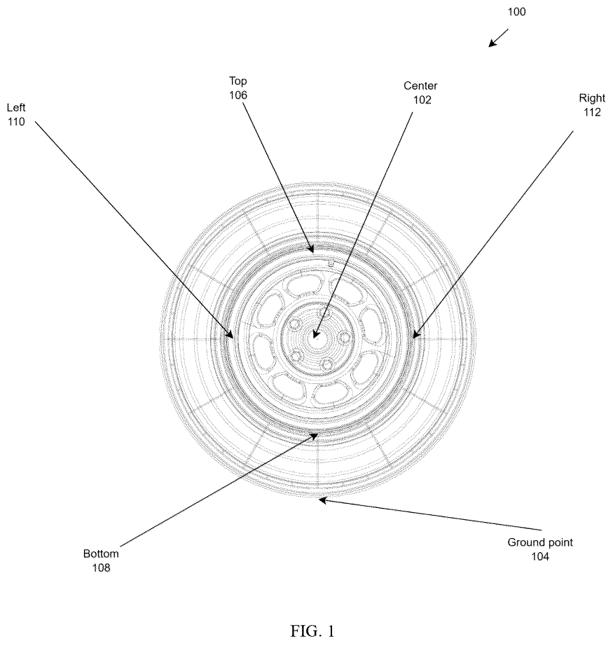

At least two key points are generally required, one at the wheel center and another at the wheel rim. With three or more key points, a mean value can be calculated. In an exemplary embodiment, a head presents coordinates of 6 keypoints: 4 edges of the wheel disk, the disk center, and the point where the wheel touches the ground. In this embodiment, the 4 edges of the wheel disk comprise top, right, bottom, and left. FIG. 1 shows an exemplary embodiment 100 of a racing wheel comprising center 102, ground point 104, wheel disk top 106, wheel disk bottom 108, wheel disk left 110, and wheel disk right 112. An exemplary loss function is used, such as mean-squared error. The input of the model is a 3-channel 512×512 image. The radius of the wheel disk is calculated from the keypoint detections. Two lines are drawn, where one line connects the centers of the disks and another line connects the points where the wheels touch the ground. The size of the wheel disk radius is known in advance. Thus, distances of interest, such as line lengths can be automatically calculated based on this information. For example, the number of inches (or centimeters) in one pixel can be determined because the radius in pixels is known from the results of key-point detection. In one embodiment, radius length is a key measurement length, as all other measurements can be based on radius length.

The dataset for the module is collected similarly to the datasets for the other modules. The keypoints dataset includes car wheels crops with six keypoints coordinates. If the point of ground touch is not available on the wheel crop, the coordinate is used instead. For example, the coordinate can have the form “image_width/2,0. The training set in an exemplary embodiment comprises about 2900 images.

An exemplary evaluation of the dataset for this module comprises Common Objects in Context (COCO) metrics. The COCO dataset is a comprehensive resource in computer vision, and includes large scale, diversity, and detailed annotation, making it a useful benchmark for assessing modern vision algorithms. When applied to Keypoint R-CNN, COCO's standardized metrics, including Average Precision (AP) and Average Recall (AR) across various Intersection over Union (IoU) thresholds and object scales, are crucial. Specifically, the dataset's metrics for keypoint detection, like the Object Keypoint Similarity (OKS)-based AP, play a significant role in evaluating and benchmarking the performance of Keypoint R-CNN models. This benchmarking is essential not only for comparing state-of-the-art models but also for identifying and addressing weaknesses in Keypoint R-CNN models. In an exemplary embodiment, the main metrics for a test dataset of 288 images produced an AP values of 0.977 and an AR value of 0.986.

In an embodiment, automatic detail measurement uses multiple models. For example, dedicated models are used for detecting wheel bounding boxes and car orientation. These dedicated models can be used in specific sequences. For example, a race-car detection model is used to identify racing cars in the image data. Then a car orientation model uses the results of the car-detection model as inputs to calculate the probability of the car being in various orientations.

A module for detection of racing cars relies on attributes that are particularly significant for racing cars, such as car numbers or car manufacturers. A cropped image of a detected car serves as a starting point for image analysis and classification. A detected-car image comprises the car's number and the manufacturer's branding. Detected car numbers can be used to identify cars in a race. Manufacturer brand detection is useful because it reduces classification errors. Racing teams generally use cars from different manufacturers so detected manufacturer brands can be used to more accurately identify cars.

Detection of car numbers and manufacturers comprises the use of a deep learning based object detector models such as EfficientDet. Multiple models are used, trained on different data sets. For example, one model is trained specifically for car detection. A second model is trained for detecting racing car attributes such as car numbers or manufacturer's brands. The model, such as EfficientDet, uses a bi-directional feature network (BiFPN) and special scaling rules. Each network component, such as backbone, feature, and box or class prediction network, has a single compound scaling factor that controls all scaling dimensions using heuristic-based rules. Model inferences must be made quickly so that photos can be processed as close to real-time as possible. EfficientNet is anchor based and trained using a k-means clustering algorithm on a dataset to find aspect ratios of anchor boxes. In an embodiment, 3-channel images are resized in training to 512×512.

AdamW optimizer with learning rate 0.001 and cosine annealing learning rate schedule can be utilized. AdamW optimization is a stochastic gradient descent method based on adaptive estimation of first-order and second-order moments, with an added method to decay weights.

AdamW modifies the typical implementation of weight decay in Adam by decoupling weight decay from the gradient update. In Adam, L2 regularization is usually implemented with the modification where wt is the rate of the weight decay at time t according to Equation 1:

$${g}_{t} = ∇ f ( {θ}_{t} ) + {w}_{t} {θ}_{t} \vert {g}_{t} = ∇ f ( {θ}_{t} ) + {w}_{t} {θ}_{t} \qquad ( Equation 1 )$$

while AdamW adjusts the term of weight decay appearing in the gradient update in Equation 2:

$${θ}_{t + 1 , i} = {θ}_{t , i} - η ( \frac{1}{\sqrt{\hat{v} + ∈}} \cdot {\hat{m}}_{t} + {w}_{t , i} {θ}_{t , i} ) , ∀ t \vert {θ}_{t + 1 , i} = {θ}_{t , i} - η ( \frac{1}{\sqrt{\hat{v} + ∈}} \cdot {\hat{m}}_{t} + {w}_{t , i} {θ}_{t , i} ) , ∀ t \qquad ( Equation 2 )$$

AdamW yields models with improved generalization capabilities and is thus able to compete with Stochastic Gradient Descent (SGD).

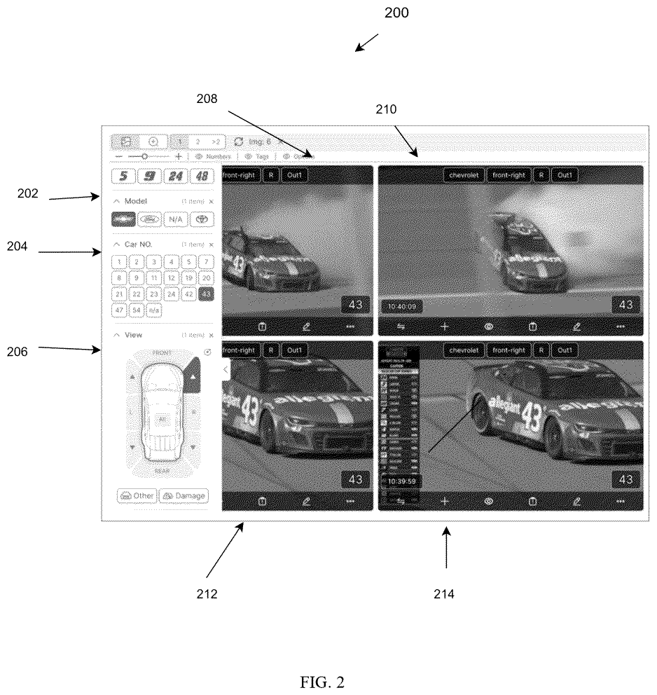

In an embodiment, a dedicated model is used for the detection of car numbers. The car-number detection model takes as input a cropped number from an attributes detection model. A car number is predicted from the cropped number. Car numbers present a technical problem for model training because not all car numbers are available in the training dataset. Fonts and colors also vary between cars and from one race to another. A heuristic algorithm is used to find image patches with separate digits. Each patch is then processed with EfficientNet to predict the digit. The digit-recognition model is trained using a cross-entropy loss function. Predicted digits are combined to obtain a final car number prediction. In an embodiment, a dedicated model is used for brand recognition; for example, a lightweight EfficientNet backbone with a classification head for 4 classes. An example of brand recognition by such a model is illustrated in FIG. 2 where cars by a certain manufacturer are divided into the classes Chevrolet, Ford, Toyota, or no brand (N/A). An exemplary GUI 200 of an application interface is shown in FIG. 2. The interface shows the detection results of car model 202, detection results of car number 204, and detection results of orientation 206 for images 208, 210, 212, and 214. FIG. 2 shows an embodiment of the application configured for use with NASCAR images

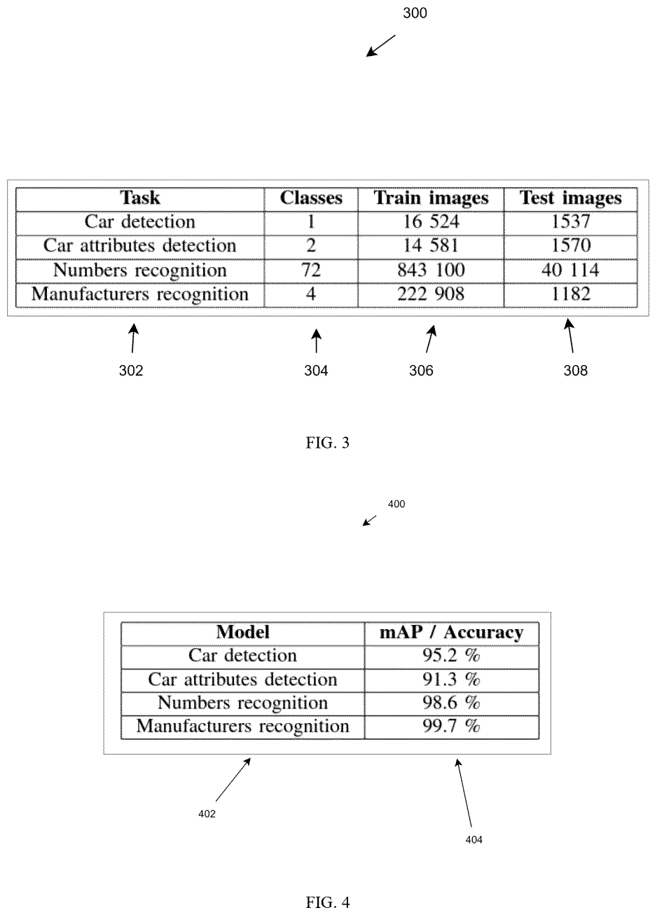

In an embodiment, a dataset comprising NASCAR racing photo images is used to build datasets for dedicated tasks. Exemplary datasets 300 are shown in FIG. 3. Tasks 302 comprise car detection, attributes detection, numbers recognition, and manufacturers recognition. The number of classes 304 for each task are 1 for car detection, 2 for car attributes detection, 72 for numbers recognition, and 4 for manufacturers recognition. For example, car detection can use one class, images with a car. Manufacturer recognition in the context of FIG. 2 uses four classes, one for each of three manufacturers and a catch all for no recognized manufacturer (e.g. “N/A”). Training images are used to train machine-learning models. The test images are not used for training the model but used for testing the accuracy of the trained model. In an embodiment, the number of training images 306 for each category are 16,524 for car detection, 14,581 for car attributes detection, 843,100 for numbers recognition, and 222,908 for manufacturer recognition. The number of test images is 1537 for car detection, 1570 for car attributes detection, 40,114 for numbers recognition, and 1182 for manufacturer recognition.

Datasets can be updated with new racing images and through user feedback. For example, images can be added by way of an application interface provided by a GUI engine. The car numbers recognition dataset can be enhanced by using synthetic data generation. In an embodiment, Big Generative Adversarial Network (BigGAN) is trained to generate dataset images. For example, 0.2% of the dataset images can be generated with BigGAN. BigGAN is an advanced version of the standard GAN architecture configured to produce high-quality and high-resolution images. BigGAN is distinguished from traditional GANs by its large scale, both in terms of the size of the model and the amount of training data used. BigGAN employs a deep neural network enabling it to generate more detailed and complex images than traditional GANs.

BigGAN uses larger batch sizes, increasing the width (number of nodes) in each layer, adding skip connections from the latent (unobserved or hidden) variable z to further layers, and a new variant of Orthogonal Regularization. A key feature of BigGAN is its ability to maintain stability during training, despite its size, which is achieved through techniques such as orthogonal regularization and the use of large mini-batch sizes.

In an embodiment, the models are tested offline to evaluate their respective results. For example, in detection tasks, a standard mean average precision (mAP) can be used. For recognition tasks, an accuracy metric can be employed. Exemplary results 400 are shown in FIG. 4. The models 402 comprise car detection, car attributes detection, number recognition, and manufacturers recognition. In an embodiment, each of models 402 is trained separately for its respective task. By way of example, a standard mean accuracy precision (mAP/Accuracy) 404 is shown for each model. The accuracy is 95.2% for the car detection model, 91.3% for the car attributes detection model, 98.6% for the numbers recognition model, and 99.7% for the manufacturers recognition model.

In an embodiment, a module for detection of race car orientation is used. The module for detection of race car orientation includes a model for analyzing photo streams from different cameras around a race track. This model allows different cars to be clustered so that the time to match cars is reduced.

For car-orientation prediction, a multi-class classification model is used. The model predicts an array of probabilities that can be used to define a car's orientation. For example, 8 classes can be used. In this embodiment, the classes include front, front-left, front-right, rear, rear-left, rear-right, left, and right. The model is based on the EfficientNet model with certain modifications. As its starting point, the car-orientation model uses the results of the car-detection model described above in connection with attribute detection. For example, the model takes a cropped 3-channel image of a car with a shape of 100×200 as input and returns an array with probabilities for each orientation. When the model is trained, an AdamW optimizer is used, along with a scheduler that reduces the learning rate when a metric stops improving. In an embodiment, the initial learning rate is set to 0.01, with a reduction factor of 0.1.

Class balancing techniques are applied to handle imbalanced data. In an embodiment, various techniques are used to address class imbalance, which occurs when certain classes are overrepresented compared to others. Resampling methods include both oversampling the minority class, where instances are replicated or synthetically created using techniques like Synthetic Minority Over-sampling Techniques (SMOTE) and undersampling the majority class by reducing majority class instances. Ensemble methods, such as Balanced Random Forest and adjusted boosting algorithms like AdaBoost, create multiple balanced datasets or emphasize minority class instances during training. Cost-sensitive learning assigns different weights to classes, focusing more on the minority class, while artificial data generation uses approaches like Generative Adversarial Networks (GANs) to generate new instances of underrepresented classes. GANs are a class of artificial intelligence algorithms used in unsupervised machine learning, implemented by a system of two neural networks contesting with each other in a game-theoretic scenario. Threshold moving adjusts the decision boundary in probabilistic models to be more inclusive of the minority class. Data augmentation can also be used to modify versions of minority class instances to enhance their representation in the dataset.

A dataset is collected to train, evaluate, and test the car-orientation model. For example, a dataset for configuring prediction of the orientation of vehicles in NASCAR races comprises a large number of NASCAR photos. In an embodiment, over 100,000 images are used. The images are taken from multiple events, for example, more than 100 events. Objects in the images include cars with different paint schemes under various conditions, including nighttime, daytime, and rainy, clear, or sunny weather. These images are labeled either manually or automatically, or semi-automatically, as with the other images described above. In an exemplary embodiment, the dataset is divided so that 70% of the images are used for training, 10% for validation, and 20% for testing.

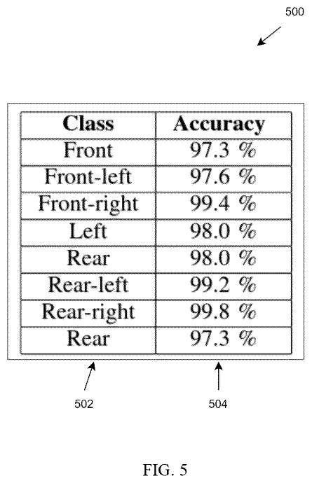

Offline testing can be used to evaluate the car-orientation model's ability to detect car orientation. The results of an exemplary test in a NASCAR setting are shown in FIG. 5. Results 500 are sorted by class 502 and accuracy 504. The classes 502 comprise a breakdown of 360 degrees into 8 categories: front, front-left, front-right, left, rear, rear-left, rear-right, and rear. The accuracy results 504 for each of the 8 classes 502 are 97.3%, 97.6%, 99.4%, 98.0%, 98%, 99.2%, 99.8%, and 97.3%, respectively.

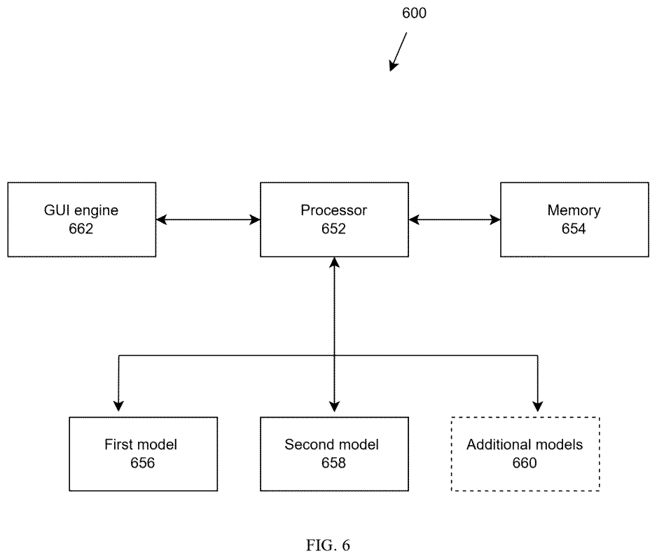

FIG. 6 shows an exemplary system 600 for identifying attributes of racing vehicles according to an embodiment. System 600 generally comprises a processor 652, a memory 654 operably coupled to processor 652, a first machine-learning model 656, a second machine-learning model 658, optionally additional models 660, and a graphical user interface (GUI) engine 662.

First machine-learning model 656 can comprise a machine learning model trained to identify a racing vehicle in images. Second machine-learning model 658 can comprise a machine learning model trained to recognize numbers on racing vehicles in images. In an embodiment, second machine-learning model 658 is further trained to analyze cropped images with car numbers.

In an embodiment, second machine-learning model 658 comprises a heuristic algorithm configured to find image patches with separate digits. In an embodiment, second machine-learning model 658 is further configured to process the image patches to predict the digits. In an embodiment, second machine-learning model 658 is further configured to combine the predicted digits to produce a car-number prediction for the racing vehicle. Optional additional models 660 can comprise one or more additional machine learning models trained for tasks described herein, including detecting racing teams or measurement of car details. GUI engine 662 is configured to present an interface regarding the analysis conducted by system 600. The interface can be used to present outputs of the different machine-learning modules into a single, combined format.

Alternatively, the interface can focus on one or more specific attributes of the racing vehicles extracted from the images.

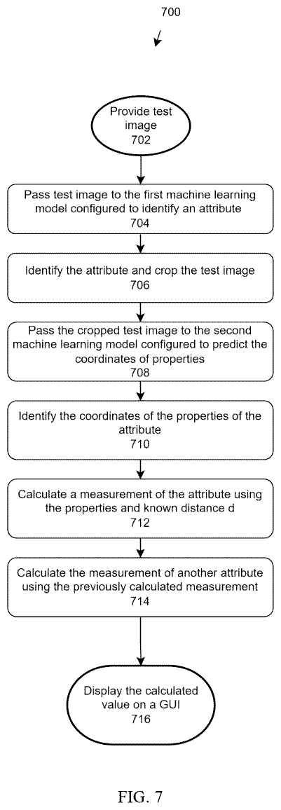

FIG. 7 is a flowchart of a method 700 for automatic detection of attributes from an image of a racing vehicle. Operations of method 700 are implemented by a system such as shown in FIG. 6, using a plurality of machine-learning models.

At 702, a test image of a racing vehicle is provided for analysis. This image has no scale so the image scale cannot be accurately correlated to the scale of the actual racing vehicle. The test image is passed at 704 to a first machine-learning model configured to identify an attribute of the racing vehicle. The first attribute comprises a component of a racing vehicle with a known distance d. For example, the known distance can be the standard wheel radius used in NASCAR racing vehicles or other standard component dimensions. At 706, the first machine-learning model identifies the attribute, such as with a bounding box outlining a wheel, and crops the test image so that the first attribute becomes the main object in the cropped test image. The cropped test image is passed at 708 to a second machine-learning model, which is configured to predict the coordinates of at least four properties of the first attribute of the racing vehicle. For example, in the case of a wheel the coordinates can include the edges and center of the wheel.

A machine-learning model configured to detect racing vehicle orientation can be used to improve the accuracy of the measurement. For example, when the detected attribute is a wheel, images taken from a side view of the car will show distances with less distortion than other angles. In an embodiment, images are filtered using an orientation-detection model so that side views can be selected for processing.

In an embodiment, a matrix transformation based on the coordinates of the at least four properties of the first attribute of the racing vehicle and a reference point is used. In this embodiment, the digital test image is corrected using the transformation matrix. In this context, a transformation matrix is a numerical array that encodes linear transformations applied to pixel coordinates. The transformation matrix facilitates image manipulations such as translation, rotation, scaling, and shearing. During transformation, the matrix multiplies with each pixel's original coordinates, generating new coordinates that define the pixel's location in the transformed image.

The second machine-learning model then identifies at 710 the coordinates of the at least four properties of the first attribute of the racing vehicle. These coordinates are then used to calculate at 712 a first measurement of the first attribute using the coordinates of the at least four properties of the attribute and known distance d. The results of this calculation are used to calculate a second measurement at 714 of a second attribute using the first measurement as an input. For example, the first measurement takes the known distance d (wheel radius) and the relative positions of the at least four wheel attributes to extrapolate and determine the distance from one wheel to another. At 716, the extrapolated, calculated value of the second measurement is displayed on a graphical user interface. The specific measurement displayed can vary based on the attribute of interest for the user.

In an exemplary embodiment, the application, including modules executed by at least one processor and an operably coupled memory, is deployed on a virtual machine using a cloud service provider such as Microsoft Azure. Bare metal deployments may also be used. Generally speaking, hardware and software compatible with machine-learning applications is preferable. An example of such a deployment comprises a virtual machine configured with four virtual CPUs, 16 GB RAM, and one virtual GPU, such as the Nvidia Tesla K80 with 12 GB memory. Data storage can be handled by a database such as MongoDB. In an embodiment, the deep learning models described above are trained and deployed using the PyTorch library.

Collection of images for the datasets may mostly or entirely comprise digital images that focus on cars in racing events, such that images without cars make up an extremely small percentage of the images. User feedback images can also be used. User feedback images are used to enhance model accuracy and generalizability. The application optionally accepts user feedback in the form of labeled images. This operation integrates human expertise into the dataset, providing annotations and corrections. For instance, users might label specific car models, features, or attributes that the model initially misinterpreted or overlooked. This intervention helps align the model's outputs more closely with real-world variations and intricacies in image interpretation. Images labeled by users can be reintegrated into the test datasets. This integration provides a more comprehensive basis for the model, encompassing a broader range of real-world scenarios. In exemplary embodiments, the average percentage of images with no car returned by the application is less than 1% and the average number of feedback images is also 1%. These percentages are consistent with positive user experience and also provide useful updates for the test datasets.

1. A computer-implemented method for automatically measuring and displaying attributes of racing vehicle images, the method comprising:
providing a digital test image including a racing vehicle;
passing the digital test image to a first machine-learning model configured to identify an attribute of the racing vehicle, wherein a first attribute comprises a component of a racing vehicle with a known distance d;
identifying, by the first machine-learning model, the first attribute and cropping the digital test image to emphasize the first attribute;
passing the cropped digital test image to a second machine-learning model configured to predict coordinates of at least four properties of the first attribute of the racing vehicle;
calculating a first measurement of the first attribute using the coordinates of the at least four properties of the attribute and known distance d;
calculating a second measurement of a second attribute using the first measurement as an input;
displaying the calculated value of the second measurement on a graphical user interface; and
changing a component of a racing vehicle corresponding to the second attribute based on the calculated value of the second measurement.

2. The method of claim 1, further comprising:
identifying, by the second machine-learning model, the coordinates of the at least four properties of the first attribute of the racing vehicle; and
defining a matrix transformation based on the coordinates of the at least four properties of the first attribute of the racing vehicle and a reference point; and correcting the digital test image using the transformation matrix.

3. The method of claim 1, wherein the first attribute is a first wheel of the racing vehicle.

4. The method of claim 3, wherein the first measurement is the radius of the first wheel.

5. The method of claim 4, wherein the second measurement is a distance between the first wheel of the racing vehicle and a second wheel of the racing vehicle.

6. The method of claim 3, wherein the known distance d is a wheel disk radius.

7. The method of claim 3, wherein the at least four properties of the first attribute are locations on the first wheel.

8. The method of claim 7, wherein the at least four properties comprise coordinates of a top, bottom, left side, and right side of the first wheel.

9. The method of claim 8, wherein the at least four properties further comprise a center of the first wheel and a point at which a tire coupled to the first wheel touches the ground.

10. A system for identifying attributes of racing vehicles from test images, the system comprising;
a test image of a racing vehicle;
a microprocessor processor coupled to a nonvolatile storage medium, configured with instructions that, when executed by the processor, control a plurality of machine-learning modules, the modules comprising:
a first machine-learning model trained to identify an attribute of a racing vehicle, wherein a first attribute comprises a component of a racing vehicle with a known distance d;
a second machine-learning model trained predict at least four properties of the first attribute of the racing vehicle, wherein the second machine-learning model is configured to predict coordinates of the at least four properties of the first attribute of the racing vehicle;
a software module, under microprocessor control, configured for calculating a first measurement of the first attribute using the coordinates of the at least four properties of the attribute and known distance d, wherein the software module is further configured for calculating a second measurement of a second attribute using the first measurement as an input; and
a graphical user interface, under microprocessor control, configured for displaying the second measurement to a user,
wherein the software module is further configured for changing a component of a racing vehicle corresponding to the second attribute based on the calculated value of the second measurement.

11. The method of claim 10, wherein the first attribute is a first wheel of the racing vehicle.

12. The method of claim 11, wherein the first measurement is the radius of the first wheel.

13. The method of claim 12, wherein the second measurement is a distance between the first wheel of the racing vehicle and a second wheel of the racing vehicle.

14. The method of claim 10, wherein the known distance d is a wheel disk radius.

15. The method of claim 11, wherein the at least four properties of the first attribute are coordinates on the first wheel.

16. The method of claim 11, wherein the at least four properties comprise coordinates of a top, bottom, left side, and right side of the first wheel.

17. A computer-implemented method for training a plurality of machine-learning models for measuring attributes of racing vehicles, the method comprising:
collecting training images of a plurality of racing vehicles;
training a first machine-learning model with the plurality of training images to identify a a first attribute of the racing vehicles;
training a second machine-learning model to predict the coordinates of at least four properties of the first attribute of the racing vehicles;
passing a test image of a racing vehicle to the first machine-learning model;
detecting, by the first machine-learning model, a bounding box of the first attribute;
cropping the test image to emphasize the bounding box of the first attribute to generate a cropped test image;
passing the cropped test image to the second machine-learning model;
identifying, by the second machine-learning model, coordinates of the at least four properties;
calculating a first measurement of the first attribute using the coordinates of the at least four properties of the attribute and the known distance d;
calculating a second measurement of a second attribute using the first measurement as an input;
displaying the calculated value of the second measurement on a graphical user interface; and
changing a component of a racing vehicle corresponding to the second attribute based on the calculated value of the second measurement.

18. The method of claim 17, wherein the first attribute is a first wheel of the racing vehicle.

19. The method of claim 18, wherein the first measurement is the radius of the first wheel.

20. The method of claim 17, wherein the known distance d is a wheel disk radius.
